(19) United States
(12) Patent Application Publication
(10) Pub. No.: US 2024/0037856 A1
(43) Pub. Date: Feb. 1, 2024

(54) WALKTHROUGH VIEW GENERATION METHOD, APPARATUS AND DEVICE, AND STORAGE MEDIUM

(71) Applicant: Beijing Bytedance Network Technology Co., Ltd., Beijing (CN)

(72) Inventors: Shaohui JIAO, Beijing (CN); Xin LIU, Beijing (CN); Yue WANG, Beijing (CN); Yongjie ZHANG, Beijing (CN)

(21) Appl. No.: 18/276,139

(22) PCT Filed: Jan. 29, 2022
(86) PCT No.: PCT/CN2022/074910

§ 371 Date: Aug. 7, 2023

(30) Foreign Application Priority Data
Feb. 7, 2021 (CN) 202110168916.8

(51) Int. Cl. G06T 19/00; G06T 15/20; G06T 17/00; G06T 7/55; G06T 3/40

(52) U.S. Cl. CPC G06T 19/003; G06T 15/205; G06T 17/00; G06T 7/55; G06T 3/4038

(57) ABSTRACT

Provided a walkthrough view generation method, apparatus and device, and a storage medium. The method includes acquiring an initial three-dimensional model and a repaired three-dimensional model corresponding to the initial three-dimensional model in the same spatial region, and the repaired three-dimensional model is obtained by repairing the spatial information in the initial three-dimensional model; determining a first intersection-point set between walkthrough light rays corresponding to current walkthrough parameters and the initial three-dimensional model and a second intersection-point set between the walkthrough light rays and the repaired three-dimensional model respectively, the current walkthrough parameters include a walkthrough viewing position after moving and a walkthrough viewing angle after moving; and fusing the initial three-dimensional model and the repaired three-dimensional model according to the depth differences between intersection-points of the first intersection-point set and corresponding intersection-points of the second intersection-point set and rendering the fused result to obtain the current walkthrough view.

This application claims priority to Chinese Patent Application No. 202110168916.8 filed with the China National Intellectual Property Administration (CNIPA) on Feb. 7, 2021, the disclosure of which is incorporated herein by reference in its entirety.

### TECHNICAL FIELD

Embodiments of the present application relate to the field of image processing technology, for example, a walkthrough view generation method, apparatus and device, and a storage medium.

### BACKGROUND

With the continuous development of virtual reality (VR) technology, the VR technology is applied in more and more service scenarios. In the application of the VR technology, a virtual scenario walkthrough needs to be implemented. At present, the virtual scenario walkthrough is implemented by a 360-degree panoramic image. In this manner, during a panoramic walkthrough, a user can only view the 360-degree panoramic image at a fixed viewing position by changing a viewing angle, that is, only walkthrough at a three-degree of freedom can be implemented. However, when the user changes the view position, the displayed walkthrough view tends to be deformed and distorted, resulting in an unreality.

### SUMMARY

For the case in the related art where when a user changes his viewing position, the displayed walkthrough view tends to be deformed and distorted, the present application provides a walkthrough view generation method, apparatus and device, and a storage medium.

In a first aspect, an embodiment of the present application provides a walkthrough view generation method. The method includes the steps below.

An initial three-dimensional model and a repaired three-dimensional model corresponding to the initial three-dimensional model in the same spatial region are acquired. The repaired three-dimensional model is obtained by repairing the spatial information in the initial three-dimensional model.

A first intersection-point set between walkthrough light rays corresponding to the current walkthrough parameters and the initial three-dimensional model and a second intersection-point set between the walkthrough light rays and the repaired three-dimensional model are determined respectively. The current walkthrough parameters include a walkthrough viewing position after moving and a walkthrough viewing angle after moving.

The initial three-dimensional model and the repaired three-dimensional model are fused according to the depth differences between intersection-points of the first intersection-point set and corresponding intersection-points of the second intersection-point set, and the fused result is rendered to obtain the current walkthrough view.

In a second aspect, an embodiment of the present application provides a walkthrough view generation apparatus. The apparatus includes an acquisition module, a determination module, and a processing module.

The acquisition module is configured to acquire the initial three-dimensional model and the repaired three-dimensional model corresponding to the initial three-dimensional model in the same spatial region. The repaired three-dimensional model is obtained by repairing the spatial information in the initial three-dimensional model.

The determination module is configured to determine the first intersection-point set between the walkthrough light ray corresponding to the current walkthrough parameters and the initial three-dimensional model and the second intersection-point set between the current walkthrough parameters and the repaired three-dimensional model respectively. The current walkthrough parameters include a walkthrough viewing position after moving and a walkthrough viewing angle after moving.

The processing module is configured to fuse the initial three-dimensional model and the repaired three-dimensional model according to the depth differences between intersection-points of the first intersection-point set and corresponding intersection-points of the second intersection-point set and render the fused result to obtain the current walkthrough view.

In a third aspect, an embodiment of the present application provides a walkthrough view generation device. The device includes a memory and a processor. The memory stores a computer program. The processor, when executing the computer program, performs the steps of the walkthrough view generation method according to the first aspect of embodiments of the present application.

In a fourth aspect, an embodiment of the present application provides a computer-readable storage medium. The storage medium stores a computer program. The computer program, when executed by a processor, performs the steps of the walkthrough view generation method according to the first aspect of the embodiments of the present application.

### BRIEF DESCRIPTION OF DRAWINGS

Throughout the drawings, same or similar reference numerals in the drawings denote same or similar elements. It is to be understood that the drawings are illustrative and that originals and elements are not necessarily drawn to scale.

FIG. 1 is a flowchart of a walkthrough view generation method according to an embodiment of the present application.

FIG. 2 is a flowchart of the acquisition process of an initial three-dimensional model and a repaired three-dimensional model according to an embodiment of the present application.

FIG. 3 is a flowchart of the generation process of a panoramic depth image according to an embodiment of the present application.

FIG. 4 is a flowchart of the generation process of a repaired panoramic depth image according to an embodiment of the present application.

FIG. 5 is a flowchart of the generation process of a repaired panoramic color image according to an embodiment of the present application.

FIG. 6 is a principle diagram of the generation process of a repaired panoramic depth image and a repaired panoramic color image according to an embodiment of the present application.

FIG. 7 is a diagram illustrating the structure of a walkthrough view generation apparatus according to an embodiment of the present application.

FIG. 8 is a diagram illustrating the structure of a walkthrough view generation device according to an embodiment of the present application.

### DETAILED DESCRIPTION

Embodiments of the present disclosure are described in more detail hereinafter with reference to the drawings. Although some embodiments of the present disclosure are shown in the drawings, it is to be understood that the present disclosure may be implemented in various forms and should not be construed as limited to the embodiments set forth herein. Conversely, these embodiments are provided so that the present disclosure is thoroughly and completely understood. It should be understood that drawings and embodiments of the present disclosure are merely illustrative and are not intended to limit the scope of the present disclosure.

It is to be understood that the various steps recited in the method embodiments of the present disclosure may be performed in a different order, and/or in parallel. Additionally, the method embodiments may include an additional step and/or omit performing an illustrated step. The scope of the present disclosure is not limited in this respect.

As used herein, the term “include” and variations thereof are intended to be inclusive, that is, “including, but not limited to”. The term “based on” is “at least partially based on”. The term “one embodiment” means “at least one embodiment”; the term “another embodiment” means “at least one another embodiment”; and the term “some embodiments” means “at least some embodiments”. Related definitions of other terms are given in the description hereinafter.

It is to be noted that references to “first”, “second” and the like in the present disclosure are merely intended to distinguish one from another apparatus, module, or unit and are not intended to limit the order or interrelationship of the functions performed by the apparatus, module, or unit.

It is to be noted that references to modifications of “one” or “a plurality” mentioned in the present disclosure are intended to be illustrative and not limiting; and those skilled in the art should understand that “one” or “a plurality” should be understood as “one or more” unless clearly expressed in the context.

The names of messages or information exchanged between multiple apparatuses in the embodiments of the present disclosure are only for illustrative purposes and are not intended to limit the scope of such messages or information.

At present, during a panoramic walkthrough, a user can only view a 360-degree panoramic image at a fixed viewing position by changing a viewing angle. However, when the user changes the viewing position, a displayed walkthrough view tends to be deformed and distorted, resulting in an unreality. That is, the walkthrough in the related art can only be implemented in a three-degree of freedom walkthrough mode. For this reason, in the solutions provided by the embodiments of the present application, a six-degree of freedom walkthrough mode in which a viewing position and a viewing angle may be changed can be provided.

For the convenience of those skilled in the art to understand, the concepts of three-degree of freedom and six-degree of freedom are described below.

The three-degree of freedom refers to that the degrees of freedom have three rotation angles, that is, the three-degree of freedom has only the ability to rotate on the X, Y, and Z axes, and does not have the ability to move on the X, Y, and Z axes.

The six-degree of freedom refers to that the degrees of freedom have three degrees of freedom about rotation angles as well as three degrees of freedom about positions such as moving up and down, moving front and back, and moving left and right, that is, the six-degree of freedom not only has the ability to rotate on the X, Y, and Z axes, but also has the ability to move on the X, Y, and Z axes.

The object, solutions, and advantages of the present application are clearer from a detailed description of the embodiments of the present application in conjunction with the drawings. It is to be noted that if not in collision, the embodiments and features therein in the present application may be combined with each other.

It is to be noted that the execution entity of the method embodiments described below may be a walkthrough view generation apparatus. The apparatus may be implemented as part or entirety of a walkthrough view generation device (hereinafter referred to as an electronic device) by means of software, hardware, or a combination of software and hardware. For example, the electronic device may be a client, including but not limited to a smartphone, a tablet computer, an electronic book reader, and an in-vehicle terminal. Of course, the electronic device may be an independent server or a server cluster, and the specific form of the electronic device is not limited in the embodiments of the present application. The method embodiments below is illustrated by using an example in which the execution entity is the electronic device.

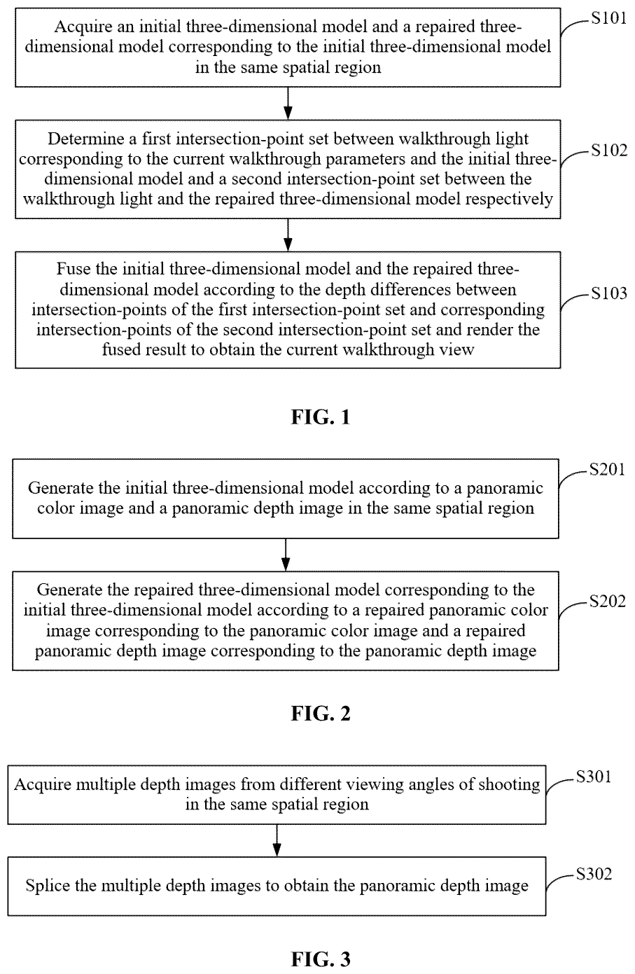

FIG. 1 is a flowchart of a walkthrough view generation method according to an embodiment of the present application. This embodiment relates to the process of how the electronic device generates a walkthrough view. As shown in FIG. 1, the method may include the steps below.

In S101, an initial three-dimensional model and a repaired three-dimensional model in the same spatial region are acquired and the repaired three-dimensional model corresponds to the initial three-dimensional model.

The repaired three-dimensional model is obtained by repairing the spatial information in the initial three-dimensional model. The initial three-dimensional model reflects panoramic spatial information under this spatial region. The panoramic spatial information may include RGB (red, green, and blue) color information and depth information corresponding to the RGB color information. Since the same spatial region is viewed at different positions and from different viewing angles, the panoramic spatial information that can be viewed may change. For this reason, it is also necessary to fill and repair the spatial information of the initial three-dimensional model to form the corresponding repaired three-dimensional model. The preceding initial three-dimensional model and the preceding repaired three-dimensional model may be represented through a three-dimensional point cloud or a three-dimensional grid.

In practical applications, the initial three-dimensional model and the repaired three-dimensional model under the same spatial region may be pre-generated and stored at a corresponding storage position. When walkthrough display under the spatial region is required, the electronic device acquires the initial three-dimensional model and the repaired three-dimensional model under the spatial region from the corresponding storage position.

In S102, a first intersection-point set between walkthrough light rays corresponding to the current walkthrough parameters and the initial three-dimensional model and a second intersection-point set between the walkthrough light rays and the repaired three-dimensional model are determined respectively.

The current walkthrough parameters include a walkthrough viewing position after moving and a walkthrough viewing angle after moving. The walkthrough viewing angle may include a field angle and a line of sight.

In practical applications, the user may set the current walkthrough parameters. For example, the user may input the current walkthrough parameters through the parameter input box in the current display interface or may implement the walkthrough under the spatial region by adjusting the position of a virtual sensor and a shooting viewing angle. For example, the virtual sensor may be implemented by a walkthrough control, that is, the walkthrough control may be inserted in the current display interface, and the user may operate the walkthrough control to change the position of the virtual sensor and the shooting viewing angle. That is, the user may change the current walkthrough parameters in the spatial region according to actual requirements.

After the current walkthrough parameters are acquired, the electronic device may determine the intersection-points between multiple walkthrough light rays corresponding to the current walkthrough parameters and the initial three-dimensional model based on the current walkthrough parameters to obtain the first intersection-point set and determine the intersection-points between the multiple walkthrough light rays corresponding to the current walkthrough parameters and the repaired three-dimensional model to obtain the second intersection-point set. It is to be understood that each intersection-point in the first intersection-point set has the depth information under the spatial region, and each intersection-point in the second intersection-point set has also the depth information under the spatial region.

In S103, the initial three-dimensional model and the repaired three-dimensional model are fused according to the depth differences between intersection-points of the first intersection-point set and corresponding intersection-points of the second intersection-point set, and the fused result is rendered to obtain the current walkthrough view.

Since each intersection-point in the first intersection-point set has the depth information under the spatial region, and each intersection-point in the second intersection-point set has also the depth information under the spatial region, due to the differences in depth values between the intersection-points in the first intersection-point set and the corresponding intersection-points in the second intersection-point set, there is inevitably a front-to-back blocking relationship. That is, under the current walkthrough parameters, if the depth values of the partial intersection-points in the first intersection-point set are greater than the depth values of the corresponding intersection-points in the second intersection-point set, the partial intersection-points in the first intersection-point set are blocked by the corresponding intersection-points in the second intersection-point set, so that the partial intersection-points in the first intersection-point set cannot be seen. On the contrary, if the depth values of the partial intersection-points in the first intersection-point set are smaller than the depth values of the corresponding intersection-points in the second intersection-point set, the corresponding intersection-points in the second intersection-point set are blocked by the partial intersection-points in the first intersection-point set, so that the corresponding intersection-points in the second intersection-point set cannot be seen.

On this basis, after the first intersection-point set and the second intersection-point set are obtained, the electronic device needs to fuse the initial three-dimensional model and the repaired three-dimensional model based on the depth differences between the intersection-points of the first intersection-point set and the corresponding intersection-points of the second intersection-point set. That is, it is determined which intersection-points in the first intersection-point set are not blocked, which intersection-points in the first intersection-point set are blocked by corresponding intersection-points in the second intersection-point set, which intersection-points in the second intersection-point set are not blocked, and which intersection-points in the second intersection-point set are blocked by corresponding intersection-points in the first intersection-point set, so that the fused result of two three-dimensional models is obtained. Then, the fused result is rendered or drawn to obtain the current walkthrough view under the current walkthrough parameters.

It is to be understood that in a walkthrough process, a walkthrough viewing position and a walkthrough viewing angle may be changed, that is, a six-degree of freedom walkthrough mode is implemented. Thus, the walkthrough view obtained according the present disclosure belongs to a six-degree of freedom walkthrough view.

In an exemplary embodiment, the process of the preceding S103 may be calculating the depth differences between first intersection-points in the first intersection-point set and corresponding second intersection-points in the second intersection-point set one by one and using all first intersection-points whose depth differences are less than or equal to zero and all second intersection-points whose depth differences are greater than zero as the fused result of the initial three-dimensional model and the repaired three-dimensional model.

After the first intersection-point set and the second intersection-point set are obtained, the depth differences between the intersection-points of the first intersection-point set and the corresponding intersection-points of the second intersection-point set are calculated one by one based on the depth value of each intersection-point in the first intersection-point set and the depth value of each intersection-point in the second intersection-point set. All first intersection-points whose depth differences are smaller than or equal to zero are not blocked by the corresponding second intersection-points. All second intersection-points whose depth differences are greater than zero are not blocked by the corresponding first intersection-points. That is, under the current walkthrough parameters, unblocked intersection-points include all first intersection-points whose calculated depth differences are less than or equal to zero and all second intersection-points whose depth differences are greater than zero. Thus, all these unblocked intersection-points may be used as the fused result of the initial three-dimensional model and the repaired three-dimensional model.

In the walkthrough view generation method provided by this embodiment of the present application, the initial three-dimensional model and the repaired three-dimensional model corresponding to the initial three-dimensional model in the same spatial region are acquired. The first intersection-point set between the walkthrough light rays corresponding to the current walkthrough parameters and the initial three-dimensional model and the second intersection-point set between the walkthrough light rays and the repaired three-dimensional model are determined respectively. The initial three-dimensional model and the repaired three-dimensional model are fused according to the depth differences between corresponding intersection-points of the first intersection-point set and the second intersection-point set, and the fused result is rendered to obtain the current walkthrough view. Since the initial three-dimensional model and the repaired three-dimensional model in the same spatial region include spatial three-dimensional information, three-dimensional information not limited to spherical three-dimensional information may be acquired in the walkthrough process. The three-dimensional information includes depth information. In this manner, the current walkthrough view may be generated based on the depth differences between corresponding intersection-points of the first intersection-point set and the second intersection-point set. The six-degree of freedom walkthrough mode in which a viewing position and a viewing angle may be changed is implemented, and the case where a panoramic image can be viewed only at a fixed position in the related art is avoided. At the same time, since the depth information is combined in the generation process of a walkthrough view, the initial three-dimensional model and the repaired three-dimensional model may form an accurate blocking relationship based on the depth information in the fusion process. Thus, through the solutions of this embodiment of the present application, the displayed walkthrough view is not deformed and distorted.

In practical applications, the user may change the current walkthrough parameters based on actual requirements. To obtain a six-degree of freedom walkthrough view under the current walkthrough parameters, the initial three-dimensional model and the repaired three-dimensional model corresponding to the initial three-dimensional model in the same spatial region may be pre-generated. Thus, on basis of the preceding embodiments, for example, as shown in FIG. 2, the preceding S101 may include the steps below.

In S201, the initial three-dimensional model is generated according to a panoramic color image and a panoramic depth image in the same spatial region.

The panoramic color image refers to a 360-degree panoramic image having color information, and the pixel value of each pixel point included therein is represented by R, G, and B components. Each component is between (0, 255). In practical applications, the spatial region may be shot by a panoramic acquisition device including at least two cameras. The sum of the viewing angles of all camera lenses is greater than or equal to a spherical viewing angle of 360 degrees. Shot images are transmitted to a back-end processing device, and then an image processing software is used to modify the combination of the images shot by the different cameras, so that the images shot by the different cameras are smoothly combined, thereby generating the panoramic color image. That is, the color images shot from multiple viewing angles are spliced into the panoramic color image.

The panoramic depth image refers to a 360-degree panoramic image having depth information, and the pixel value of each pixel point included therein represents depth information. The depth information refers to the distance between the plane in which a camera that acquires an image is located and an object surface corresponding to the pixel point.

After the electronic device has the panoramic color image and the panoramic depth image, the electronic device may obtain the RGB color information of each pixel point and the corresponding depth information. In this manner, the electronic device may obtain the three-dimensional information representation in the spatial region based on the RGB color information of each pixel point and the corresponding depth information, thereby generating the initial three-dimensional model. The initial three-dimensional model may be represented through a three-dimensional point cloud or a three-dimensional grid.

In S202, the repaired three-dimensional model corresponding to the initial three-dimensional model is generated according to a repaired panoramic color image corresponding to the panoramic color image and a repaired panoramic depth image corresponding to the panoramic depth image.

The repaired panoramic color image refers to an image obtained after color information repair is performed on the panoramic color image. The repaired panoramic depth image refers to an image obtained after depth information repair is performed on the panoramic depth image. Since the same spatial region is viewed at different positions and from different viewing angles, the panoramic spatial information that can be viewed may change. For this reason, it is necessary to perform color information repair on the panoramic color image to obtain the repaired panoramic color image and perform depth information repair on the panoramic depth image to obtain the repaired panoramic depth image.

After the electronic device has the repaired panoramic color image and the repaired panoramic depth image, the electronic device may obtain the RGB color information of each pixel point and the corresponding depth information. In this manner, the electronic device may obtain the three-dimensional information representation in the space based on the RGB color information of each pixel point and the corresponding depth information, thereby generating the repaired three-dimensional model corresponding to the initial three-dimensional model. The repaired three-dimensional model may be represented through a three-dimensional point cloud or a three-dimensional grid.

In this embodiment, the initial three-dimensional model is generated based on the panoramic color image and the panoramic depth image in the same spatial region, and the repaired three-dimensional model corresponding to the initial three-dimensional model is generated based on the repaired panoramic color image and the repaired panoramic depth image, so that the obtained initial three-dimensional model and the obtained repaired three-dimensional model include spatial depth information. In this manner, in a walkthrough process, the current walkthrough view may be generated based on the depth differences between intersection-points of the first intersection-point set and corresponding intersection-points of the second intersection-point set.

To generate the initial three-dimensional model and the repaired three-dimensional model corresponding to the initial three-dimensional model, on basis of the preceding embodiments, for example, the method also includes generating the panoramic color image, the panoramic depth image, the repaired panoramic color image, and the repaired panoramic depth image respectively.

For example, the generation process of the panoramic color image may include acquiring multiple color images from different viewing angles of shooting in the same spatial region. The sum of different viewing angles of shooting is greater than or equal to 360 degrees. Then, transformation matrixes between the multiple color images are acquired. Coincident feature points in the multiple color images are matched based on the transformation matrix between the multiple color images. The multiple color images are spliced based on a matching result, thereby obtaining a panoramic color image.

In the following, the generation process of the panoramic depth image is described in detail. In an exemplary embodiment, as shown in FIG. 3, the generation process of the panoramic depth image may include the steps below.

In S301, multiple depth images from different viewing angles of shooting in the same spatial region are acquired.

The sum of different viewing angles of shooting is greater than or equal to 360 degrees. In practical applications, a depth camera (for example, a time of flight (TOF) camera) and a color camera may be disposed on a dedicated panoramic pan-tilt. The depth camera and the color camera are used to shoot the same spatial region, and the shooting viewing angle is continuously adjusted, thereby obtaining multiple color images and multiple depth images.

In S302, multiple depth images are spliced to obtain the panoramic depth image.

Multiple color images are spliced to obtain the panoramic color image. Multiple depth images are spliced to obtain the panoramic depth image. For example, the splicing process of the multiple depth images may include acquiring transformation matrixes between the multiple depth images and matching coincident feature points in the multiple depth images based on the transformation matrixes between the multiple depth images. The multiple depth images are spliced based on a matching result to obtain the panoramic depth image.

On basis of the preceding embodiments, for example, the process of the preceding S302 may include splicing the multiple depth images to obtain the panoramic depth image by using a same splicing method for generating the panoramic color image.

Since the multiple color images and the multiple depth images are acquired synchronously based on the same panoramic pan-tilt, when the panoramic depth image is generated, the splicing method of the multiple color images may be directly used to splice the multiple depth images, thereby improving the generation efficiency of the panoramic depth image.

At present, due to the hardware cost of the depth camera, the depth camera may have overexposure or underexposure on a smooth and bright, frosted, or transparent surface, resulting in a large number of voids in an acquired depth image. Also, with respect to the color camera, the depth acquisition range of the depth camera (including an acquisition viewing angle range and an acquisition depth range) is also limited. The depth camera cannot acquire corresponding depth information for a relatively too far or too near region. For this reason, for example, before the preceding S302, the method also includes performing depth filling and depth enhancement on the multiple depth images.

For example, for each depth image, the three-dimensional information in a color image under the same spatial region is predicted, and depth filling and depth enhancement are performed on the depth image based on the three-dimensional information. The three-dimensional information may include a depth boundary, a normal vector, and a straight line that can reflect a spatial perspective relationship. The preceding depth boundary may be understood as the contour of an object in a color image, for example, the contour of a human face. The preceding normal vector may represent a plane in a color image. The preceding spatial straight line may be a road line, a building edge line, an indoor wall corner line, or a skirting line existing in the color image.

In another exemplary embodiment, the generation process of the panoramic depth image may include inputting the panoramic color image into a first pre-trained neural network to obtain the panoramic depth image corresponding to the panoramic color image.

The first pre-trained neural network is trained based on a sample panoramic color image and a sample panoramic depth image corresponding to the sample panoramic color image.

In practical applications, the prediction of the panoramic depth image may be implemented by the first pre-trained neural network. Thus, a large amount of training data is required to train the first pre-trained neural network. In the training process of the first pre-trained neural network, training may be performed through a large number of sample panoramic color images and sample panoramic depth images corresponding to the sample panoramic color images. For example, a sample panoramic color image is used as the input of the first pre-trained neural network, and a sample panoramic depth image is used as the expected output of the first pre-trained neural network. The loss value of a preset loss function is calculated through the predicted output and the expected output of the first pre-trained neural network, and the parameter of the first pre-trained neural network is adjusted in combination with the loss value until a preset convergence condition is reached, thereby obtaining a trained first pre-trained neural network. For example, the first pre-trained neural network may be constructed by a convolutional neural network or an encoder-decoder network.

After the trained first pre-trained neural network is obtained, the panoramic color image is input into the first pre-trained neural network. The panoramic depth image corresponding to the panoramic color image may be predicted by the first pre-trained neural network.

In this embodiment, multiple depth images from different viewing angles of shooting in the same spatial region are spliced to obtain the panoramic depth image. The panoramic depth image corresponding to the panoramic color image in the same spatial region may also be predicted by the first pre-trained neural network. In this manner, the panoramic depth image is generated in a diversified manner, thereby improving the universality of the solution. Also, in the generation process of the panoramic depth image, the splicing method of the multiple color images may be directly the splicing method used to splice the multiple depth images, thereby improving the generation efficiency of the panoramic depth image.

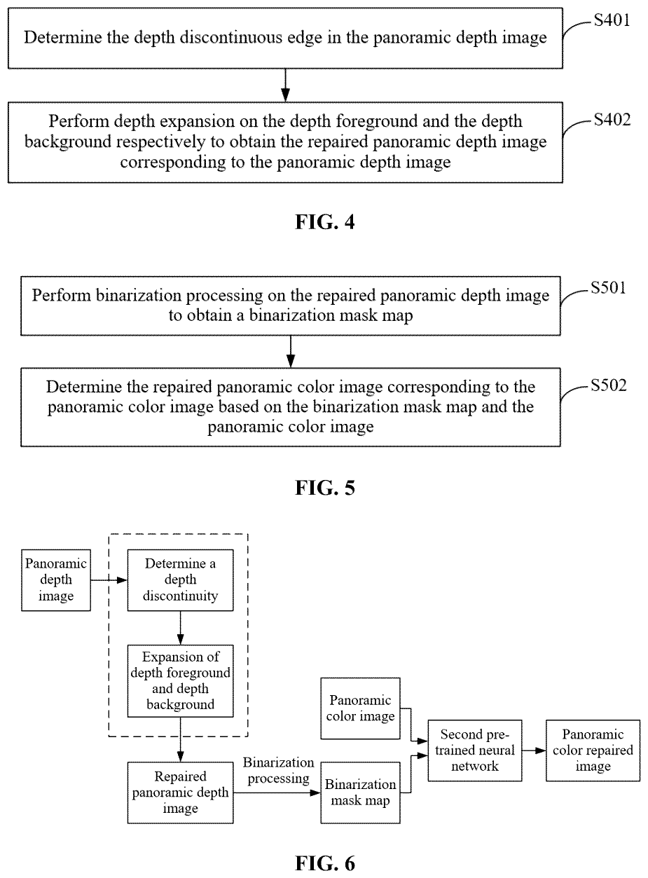

In the following, the generation process of the repaired panoramic depth image is described in detail. As shown in FIG. 4, the generation process of the repaired panoramic depth image may include the steps below.

In S401, the depth discontinuous edge in the panoramic depth image is determined.

One side of the depth discontinuous edge is depth foreground, and the other side is depth background. The depth foreground may be understood as an image where the depth discontinuous edge is adjacent to the lens position, and the depth background may be understood as an image where the depth discontinuous edge is far away from the lens position. The change of the depth value of a pixel point in the panoramic depth image is used as an important clue to find the depth discontinuity. In practical applications, a threshold value may be presented based on actual requirements. When the differences between pixel values of adjacent pixels is greater than the threshold value, the depth value is considered to have a large hop. In this case, an edge formed by the partial pixels may be considered as the depth discontinuous edge. For example, it is assumed that the set threshold value is 20, if the depth differences between adjacent pixels is 100, the edge formed by the partial pixels may be considered as the depth discontinuous edge.

In S402, depth expansion is performed on the depth foreground and the depth background respectively to obtain the repaired panoramic depth image corresponding to the panoramic depth image.

After the depth discontinuous edge in the panoramic depth image is determined, depth information repair needs to be performed on the panoramic depth image. In this case, depth expansion is performed on the depth foreground and the depth background on two sides of the depth discontinuous edge respectively. For example, a specific structure element is used for performing expansion processing on the depth foreground, and the specific structure element is used for performing expansion processing on the depth background, so that depth information repair of the depth discontinuous edge is implemented.

To generate the repaired three-dimensional model, it is necessary to perform color information repair on the corresponding region in the panoramic color image on basis of depth information repair on the depth discontinuity. For this reason, it is also necessary to generate the repaired panoramic color image.

In the following, the generation process of the repaired panoramic color image is described in detail. As shown in FIG. 5, the generation process of the repaired panoramic color image may include the steps below.

In S501, binarization processing is performed on the repaired panoramic depth image to obtain a binarization mask map.

After the repaired panoramic depth image is obtained, the electronic device may perform binarization processing on the repaired panoramic depth image to distinguish a first region in which depth repair is performed in the repaired panoramic depth image from a second region in which depth repair is not performed in the repaired panoramic depth image, which is used as the reference basis for color information repair of the panoramic color image.

In S502, the repaired panoramic color image corresponding to the panoramic color image is determined according to the binarization mask map and the panoramic color image.

After the binarization mask map is obtained, the electronic device may perform color information repair on the first region based on the first region in which depth repair is performed and the second region in which depth repair is not performed shown in the binarization mask map to obtain the repaired panoramic color image. Of course, it is also possible to repair the texture information of the first region based on the color information in the first region.

In practical applications, the repaired panoramic color image may be generated by artificial intelligence. Thus, on basis of the preceding embodiments, for example, the process of the preceding S502 may include inputting the binarization mask map and the panoramic color image into a second pre-trained neural network and performing color repair on the panoramic color image through the second pre-trained neural network to obtain the repaired panoramic color image corresponding to the panoramic color image.

The second pre-trained neural network is trained based on a sample binarization mask map, a sample panoramic color image, and a sample repaired panoramic color image corresponding to the sample panoramic color image.

The second pre-trained neural network is used to implement the information repair of the panoramic color image. For this reason, a large amount of training data is required to train the second pre-trained neural network. In the training process of the second pre-trained neural network, training may be performed through a large number of sample binarization mask maps, sample panoramic color images, and sample repaired panoramic color images corresponding to the sample panoramic color images. For example, a sample binarization mask map and a sample panoramic color image are used as the input of the second pre-trained neural network, and a sample repaired panoramic color image is used as the expected output of the second pre-trained neural network. The loss value of a preset loss function is calculated through the predicted output and the expected output of the second pre-trained neural network, and the parameter of the pre-trained neural network is adjusted in combination with the loss value until a preset convergence condition is reached, thereby obtaining a trained second pre-trained neural network. For example, the second pre-trained neural network may be constructed by a convolutional neural network or an encoder-decoder network. This is not limited in this embodiment.

After the trained second pre-trained neural network is obtained, the binarization mask map and the panoramic color image are input into the second pre-trained neural network. The second pre-trained neural network performs color information repair on the panoramic color image to obtain the repaired panoramic color image corresponding to the panoramic color image.

For the convenience of those skilled in the art to understand, the generation processes of the repaired panoramic depth image and the repaired panoramic color image are introduced according to the process shown in FIG. 6.

For example, after the panoramic depth image and the panoramic color image are obtained, the depth discontinuous edge in the panoramic depth image is determined. Depth expansion is performed on the depth foreground and the depth background on two sides of the depth discontinuous edge respectively to obtain the repaired panoramic depth image corresponding to the panoramic depth image. Then, binarization processing is performed on the repaired panoramic depth image to obtain the binarization mask map. The binarization mask map and the panoramic color image are input into the second pre-trained neural network. The repaired panoramic color image corresponding to the panoramic color image may be predicted through the second pre-trained neural network.

In this embodiment, the depth discontinuous edge in the panoramic depth image is identified, and depth expansion is performed on two sides of the depth discontinuous edge to repair the missed depth information at the depth discontinuous edge of the panoramic depth image. Also, the color information repair is performed on the panoramic color image in combination with the region of the panoramic depth image for depth repair, and the missed color information in the panoramic color image is also repaired, thereby preparing for the generation of a subsequent walkthrough view.

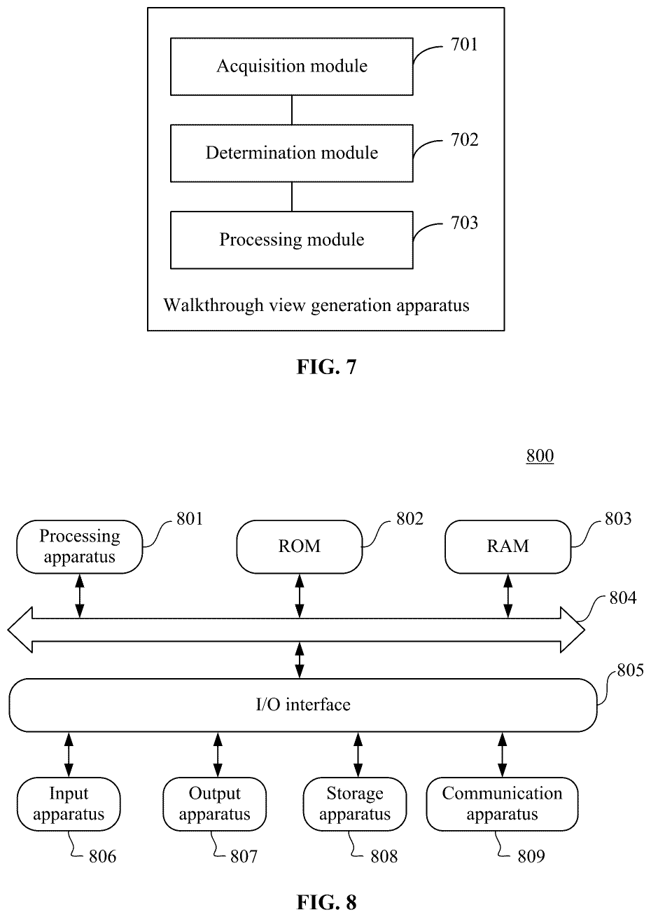

FIG. 7 is a diagram illustrating the structure of a walkthrough view generation apparatus according to an embodiment of the present application. As shown in FIG. 7, the apparatus may include an acquisition module 701, a determination module 702, and a processing module 703.

For example, the acquisition module 701 is configured to acquire an initial three-dimensional model and a repaired three-dimensional model in the same spatial region. The repaired three-dimensional model corresponds to the initial three-dimensional model and is obtained by repairing the spatial information in the initial three-dimensional model.

The determination module 702 is configured to determine a first intersection-point set between walkthrough light rays corresponding to current walkthrough parameters and the initial three-dimensional model and a second intersection-point set between the current walkthrough parameters and the repaired three-dimensional model respectively. The current walkthrough parameters include a walkthrough viewing position after moving and a walkthrough viewing angle after moving.

The processing module 703 is configured to fuse the initial three-dimensional model and the repaired three-dimensional model according to the depth differences between intersection-points of the first intersection-point set and corresponding intersection-points of the second intersection-point set and render a fused result to obtain a current walkthrough view.

In the walkthrough view generation apparatus provided by this embodiment of the present application, the initial three-dimensional model and the repaired three-dimensional model corresponding to the initial three-dimensional model in the same spatial region are acquired. The first intersection-point set between the walkthrough light rays corresponding to the current walkthrough parameters and the initial three-dimensional model and the second intersection-point set between the walkthrough light rays and the repaired three-dimensional model are determined respectively. The initial three-dimensional model and the repaired three-dimensional model are fused according to the depth differences between intersection-points of the first intersection-point set and corresponding intersection-points the second intersection-point set, and the fused result is rendered to obtain the current walkthrough view. Since the initial three-dimensional model and the repaired three-dimensional model in the same spatial region include spatial three-dimensional information, three-dimensional information not limited to spherical three-dimensional information may be acquired in the walkthrough process. The three-dimensional information includes depth information. In this manner, the current walkthrough view may be generated based on the depth differences between intersection-points of the first intersection-point set and corresponding intersection-points of the second intersection-point set. The six-degree of freedom walkthrough mode in which a viewing position and a viewing angle may be changed is implemented, and the case where a panoramic image can be viewed only at a fixed position in the related art is avoided. Also, since the depth information is combined in the generation process of a walkthrough view, the initial three-dimensional model and the repaired three-dimensional model may form an accurate blocking relationship based on the depth information in the fusion process. For this reason, through the solutions of this embodiment of the present application, the displayed walkthrough view is not deformed and distorted.

On basis of the preceding embodiments, the acquisition module 701 may include a first generation unit and a second generation unit.

For example, the first generation unit is configured to generate the initial three-dimensional model according to the panoramic color image and the panoramic depth image in the same spatial region.

The second generation unit is configured to generate the repaired three-dimensional model corresponding to the initial three-dimensional model according to the repaired panoramic color image corresponding to the panoramic color image and the repaired panoramic depth image corresponding to the panoramic depth image.

On basis of the preceding embodiments, the acquisition module 701 may also include a third generation unit.

For example, the third generation unit is configured to, before the first generation unit generates the initial three-dimensional model according to the panoramic color image and the panoramic depth image in the same spatial region, generate the panoramic color image, the panoramic depth image, the repaired panoramic color image, and the repaired panoramic depth image respectively.

On basis of the preceding embodiments, the third generation unit includes a first panoramic depth image generation subunit.

For example, the first panoramic depth image generation subunit is configured to acquire multiple depth images from different viewing angles of shooting in the same spatial region and splice the multiple depth images to obtain the panoramic depth image.

On basis of the preceding embodiments, the multiple depth images may be spliced to obtain the panoramic depth image in the following manner splicing the multiple depth images to obtain the panoramic depth image by using the same splicing method for generating the panoramic color image.

On basis of the preceding embodiments, the first panoramic depth image generation subunit is also configured to, before the multiple depth images are spliced to obtain the panoramic depth image, perform depth repair and depth enhancement on the multiple depth images.

On basis of the preceding embodiments, the third generation unit also includes a second panoramic depth image generation subunit.

For example, the second panoramic depth image generation subunit is configured to input the panoramic color image into the first pre-trained neural network to obtain the panoramic depth image corresponding to the panoramic color image. The first pre-trained neural network is trained based on the sample panoramic color image and the sample panoramic depth image corresponding to the sample panoramic color image.

On basis of the preceding embodiments, the third generation unit also includes a repaired panoramic depth image generation subunit.

For example, the repaired panoramic depth image generation subunit is configured to determine the depth discontinuous edge in the panoramic depth image and perform depth expansion on the depth foreground and the depth background respectively to obtain the repaired panoramic depth image corresponding to the panoramic depth image. One side of the depth discontinuous edge is the depth foreground, and the other side is the depth background.

On basis of the preceding embodiments, the third generation unit also includes a repaired panoramic color image generation subunit.

For example, the repaired panoramic color image generation subunit is configured to perform binarization processing on the repaired panoramic depth image to obtain the binarization mask map. The repaired panoramic color image corresponding to the panoramic color image is determined according to the binarization mask map and the panoramic color image.

On basis of the preceding embodiments, the repaired panoramic color image generation subunit is configured to input the binarization mask map and the panoramic color image into the second pre-trained neural network and perform color repair on the panoramic color image through the second pre-trained neural network to obtain the repaired panoramic color image corresponding to the panoramic color image. The second pre-trained neural network is trained based on the sample binarization mask map, the sample panoramic color image, and the sample repaired panoramic color image corresponding to the sample panoramic color image.

On basis of the preceding embodiments, the processing module 703 is configured to calculate the depth differences between first intersection-points in the first intersection-point set and corresponding second intersection-points in the second intersection-point set one by one and use all first intersection-points whose depth differences are less than or equal to zero and all second intersection-points whose depth differences are greater than zero as the fused result of the initial three-dimensional model and the repaired three-dimensional model.

Referring to FIG. 8, FIG. 8 shows a diagram illustrating the structure of an electronic device 800 suitable for implementing embodiments of the present disclosure. The electronic device in the embodiments of the present disclosure may include, but is not limited to, a mobile terminal such as a mobile phone, a laptop, a digital broadcast receiver, a personal digital assistant (PDA), a PAD, a portable media player (PMP), and a vehicle-mounted terminal (for example, a vehicle-mounted navigation terminal) and a fixed terminal such as a digital television (TV) and a desktop computer. The electronic device shown in FIG. 8 is merely an example and is not intended to limit the function and usage scope of the embodiments of the present disclosure.

As shown in FIG. 8, the electronic device 800 may include a processing apparatus 801 (such as a central processing unit and a graphics processing unit). The processing apparatus 802 may perform various types of appropriate operations and processing according to a program stored in a read-only memory (ROM) 802 or a program loaded from a storage apparatus 806 to a random-access memory (RAM) 803. Various programs and data required for the operation of the electronic device 800 are also stored in the RAM 803. The processing apparatus 801, the ROM 802, and the RAM 803 are connected to each other through a bus 804. An input/output (I/O) interface 805 is also connected to the bus 804.

Generally, the following apparatus may be connected to the I/O interface 805: an input apparatus 806 such as a touch screen, a touch pad, a keyboard, a mouse, a camera, a microphone, an accelerometer, and a gyroscope; an output apparatus 809 such as a liquid crystal display (LCD), a speaker, and a vibrator; and the storage apparatus 806 such as a magnetic tape and a hard disk, and a communication apparatus 809. The communication apparatus 809 may allow the electronic device 800 to perform wireless or wired communication with other devices to exchange data. Although FIG. 8 shows the electronic device 800 having various apparatuses, it is to be understood that not all the apparatuses shown herein need to be implemented or present. Alternatively, more or fewer apparatuses may be implemented or present.

For example, according to the embodiments of the present disclosure, the process described above with reference to the flowchart may be implemented as a computer software program. For example, the embodiments of the present disclosure include a computer program product. The computer program product includes a computer program carried in a non-transitory computer-readable medium. The computer program includes program codes for executing the method shown in the flowchart. In such an embodiment, the computer program may be downloaded from a network and installed through the communication apparatus 809, or may be installed from the storage apparatus 806, or may be installed from the ROM 802. When the computer program is executed by the processing apparatus 801, the preceding functions defined in the methods of the embodiments of the present disclosure are performed.

It is to be noted that the preceding computer-readable medium in the present disclosure may be a computer-readable signal medium, or a computer-readable storage medium, or any combination thereof. The computer-readable storage medium may be, but is not limited to, an electrical, magnetic, optical, electromagnetic, infrared or semiconductor system, apparatus or device, or any combination thereof. More specific examples of the computer-readable storage medium may include, but are not limited to, an electrical connection with one or more wires, a portable computer magnetic disk, a hard disk, a random-access memory (RAM), a read-only memory (ROM), an erasable programmable read-only memory (EPROM), a flash memory, an optical fiber, a portable compact disk read-only memory (CD-ROM), an optical memory device, a magnetic memory device, or any appropriate combination thereof. In the present disclosure, the computer-readable storage medium may be any tangible medium including or storing a program. The program may be used by or used in conjunction with an instruction execution system, apparatus, or device. In the present disclosure, the computer-readable signal medium may include a data signal propagated on a baseband or as a part of a carrier, and computer-readable program codes are carried in the data signal. The data signal propagated in this manner may be in multiple forms and includes, but is not limited to, an electromagnetic signal, an optical signal, or any suitable combination thereof. The computer-readable signal medium may further be any computer-readable medium other than the computer-readable storage medium. The computer-readable signal medium may send, propagate, or transmit a program used by or in conjunction with an instruction execution system, apparatus, or device. The program codes included on the computer-readable medium may be transmitted via any appropriate medium which includes, but is not limited to, a wire, an optical cable, a radio frequency (RF), or any appropriate combination thereof.

In some embodiments, clients and servers may communicate using any currently known or future developed network protocol, such as the Hypertext Transfer Protocol (HTTP), and may be interconnected with any form or medium of digital data communication (for example, a communication network). Examples of the communication network include a local area network (LAN), a wide area network (WAN), an internet (such as the Internet) and a peer-to-peer network (such as an ad hoc network), as well as any currently known or future developed network.

The preceding computer-readable medium may be included in the preceding electronic device or may exist alone without being assembled into the electronic device.

The preceding computer-readable medium carries one or more programs. When the one or more programs are executed by the electronic device, the electronic device is configured to acquire at least two Internet Protocol addresses; send a node evaluation request including the at least two Internet Protocol addresses to a node evaluation device, where the node evaluation device selects an Internet Protocol address from the at least two Internet Protocol addresses and returns the Internet Protocol address; and receive the Internet Protocol address returned by the node evaluation device, where the acquired Internet Protocol address indicates an edge node in a content distribution network.

Alternatively, the preceding computer-readable medium carries one or more programs. When the one or more programs are executed by the electronic device, the electronic device is configured to receive the node evaluation request including the at least two Internet Protocol addresses; select an Internet Protocol address from the at least two Internet Protocol addresses; and return the selected Internet Protocol address, where the received Internet Protocol address indicates the edge node in the content distribution network.

Computer program codes for performing the operations in the present disclosure may be written in one or more programming languages or combination thereof. The preceding one or more programming languages include, but are not limited to, object-oriented programming languages such as Java, Smalltalk and C++, as well as conventional procedural programming languages such as C or similar programming languages. Program codes may be executed entirely on a user computer, partly on a user computer, as a stand-alone software package, partly on a user computer and partly on a remote computer, or entirely on a remote computer or a server. In the case relating to the remote computer, the remote computer may be connected to the user computer via any type of network including a local area network (LAN) or a wide area network (WAN), or may be connected to an external computer (for example, via the Internet through an Internet service provider).

The flowcharts and block diagrams in the drawings show possible architectures, functions, and operations of the system, method and computer program product according to multiple embodiments of the present disclosure. In this regard, each block in the flowcharts or block diagrams may represent a module, a program segment, or part of codes that contains one or more executable instructions for implementing specified logical functions. It is also to be noted that in some alternative implementations, the functions marked in the blocks may occur in an order different from those marked in the drawings. For example, two successive blocks may, in fact, be executed substantially in parallel or in a reverse order, which depends on the functions involved. It is also to be noted that each block in the block diagrams and/or flowcharts and a combination of blocks in the block diagrams and/or flowcharts may be implemented by a specific-purpose hardware-based system which performs specified functions or operations or a combination of specific-purpose hardware and computer instructions.

The units involved in the embodiments of the present disclosure may be implemented by software or hardware. The names of the units do not constitute a limitation on the units themselves. For example, a first acquisition unit may also be described as “a unit for acquiring at least two Internet protocol addresses”.

The functions described above herein may be executed, at least partially, by one or more hardware logic components. For example, and without limitations, example types of hardware logic components that may be used include: a field-programmable gate array (FPGA), an application-specific integrated circuit (ASIC), an application-specific standard product (ASSP), a system on a chip (SOC), a complex programmable logic device (CPLD) and the like.

In the context of the present disclosure, the machine-readable medium may be a tangible medium that may include or store a program that is used by or used in conjunction with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared or semiconductor system, apparatus or device, or any suitable combination thereof. Concrete examples of the machine-readable storage medium may include an electrical connection based on one or more wires, a portable computer disk, a hard disk, a random-access memory (RAM), a read-only memory (ROM), an erasable programmable read-only memory (EPROM) or a flash memory, an optical fiber, a portable compact disc read-only memory (CD-ROM), an optical storage device, a magnetic storage device, or any appropriate combination thereof.

In an embodiment, a walkthrough view generation device is also provided. The device includes a memory and a processor. The memory stores a computer program. When executing the computer program, the processor performs the steps below.

The initial three-dimensional model and the repaired three-dimensional model corresponding to the initial three-dimensional model in the same spatial region are acquired. The repaired three-dimensional model is obtained by repairing the spatial information in the initial three-dimensional model.

The first intersection-point set between walkthrough light rays corresponding to the current walkthrough parameters and the initial three-dimensional model and the second intersection-point set between the walkthrough light rays and the repaired three-dimensional model respectively are determined. The current walkthrough parameters include a walkthrough viewing position after moving and a walkthrough viewing angle after moving.

The initial three-dimensional model and the repaired three-dimensional model are fused according to the depth differences between intersection-points of the first intersection-point set and corresponding intersection-points of the second intersection-point set and the fused result is rendered to obtain the current walkthrough view.

In an embodiment, a computer-readable storage medium is also provided. The storage medium stores a computer program. The computer program, when executed by a processor, performs the steps below.

The initial three-dimensional model and the repaired three-dimensional model corresponding to the initial three-dimensional model in the same spatial region are acquired. The repaired three-dimensional model is obtained by repairing the spatial information in the initial three-dimensional model.

The first intersection-point set between walkthrough light rays corresponding to the current walkthrough parameters and the initial three-dimensional model and the second intersection-point set between the walkthrough light rays and the repaired three-dimensional model respectively are determined. The current walkthrough parameters include a walkthrough viewing position after moving and a walkthrough viewing angle after moving.

The initial three-dimensional model and the repaired three-dimensional model are fused according to the depth differences between intersection-points of the first intersection-point set and corresponding intersection-points of the second intersection-point set and the fused result is rendered to obtain the current walkthrough view.

The walkthrough view generation apparatus and device and the storage medium provided in the preceding embodiments may execute the walkthrough view generation method provided in any embodiment of the present application and have functional modules and beneficial effects corresponding to the method executed. For technical details not described in detail in the preceding embodiments, see the walkthrough view generation method provided in any embodiment of the present application.

According to one or more embodiments of the present disclosure, a walkthrough view generation method is provided. The method includes the steps below.

The initial three-dimensional model and the repaired three-dimensional model corresponding to the initial three-dimensional model in the same spatial region are acquired. The repaired three-dimensional model is obtained by repairing the spatial information in the initial three-dimensional model.

The first intersection-point set between walkthrough light rays corresponding to the current walkthrough parameters and the initial three-dimensional model and the second intersection-point set between the walkthrough light rays and the repaired three-dimensional model respectively are determined. The current walkthrough parameters include a walkthrough viewing position after moving and a walkthrough viewing angle after moving.

The initial three-dimensional model and the repaired three-dimensional model are fused according to the depth differences between intersection-points of the first intersection-point set and corresponding intersection-points of the second intersection-point set and the fused result is rendered to obtain the current walkthrough view.

According to one or more embodiments of the present disclosure, the preceding walkthrough view generation method provided also includes generating the initial three-dimensional model according to the panoramic color image and the panoramic depth image in the same spatial region and generating the repaired three-dimensional model corresponding to the initial three-dimensional model according to the repaired panoramic color image corresponding to the panoramic color image and the repaired panoramic depth image corresponding to the panoramic depth image.

According to one or more embodiments of the present disclosure, the preceding walkthrough view generation method provided also includes generating the panoramic color image, the panoramic depth image, the repaired panoramic color image, and the repaired panoramic depth image respectively.

According to one or more embodiments of the present disclosure, the preceding walkthrough view generation method provided also includes acquiring multiple depth images from different viewing angles of shooting in the same spatial region and splicing the multiple depth images to obtain the panoramic depth image.

According to one or more embodiments of the present disclosure, the preceding walkthrough view generation method provided also includes splicing the multiple depth images to obtain the panoramic depth image by using a same splicing method for generating the panoramic color image.

According to one or more embodiments of the present disclosure, the preceding walkthrough view generation method provided also includes performing depth repair and depth enhancement on the multiple depth images.

According to one or more embodiments of the present disclosure, the preceding walkthrough view generation method provided also includes inputting the panoramic color image into the first pre-trained neural network to obtain the panoramic depth image corresponding to the panoramic color image. The first pre-trained neural network is trained based on the sample panoramic color image and the sample panoramic depth image corresponding to the sample panoramic color image.

According to one or more embodiments of the present disclosure, the preceding walkthrough view generation method provided also includes determining the depth discontinuous edge in the panoramic depth image and performing depth expansion on the depth foreground and the depth background respectively to obtain the repaired panoramic depth image corresponding to the panoramic depth image. One side of the depth discontinuous edge is the depth foreground, and the other side is the depth background.

According to one or more embodiments of the present disclosure, the preceding walkthrough view generation method provided also includes performing binarization processing on the repaired panoramic depth image to obtain the binarization mask map and determining the repaired panoramic color image corresponding to the panoramic color image based on the binarization mask map and the panoramic color image.

According to one or more embodiments of the present disclosure, the preceding walkthrough view generation method provided also includes inputting the binarization mask map and the panoramic color image into the second pre-trained neural network and performing color repair on the panoramic color image through the second pre-trained neural network to obtain the repaired panoramic color image corresponding to the panoramic color image. The second pre-trained neural network is trained based on the sample binarization mask map, the sample panoramic color image, and the sample repaired panoramic color image corresponding to the sample panoramic color image.

According to one or more embodiments of the present disclosure, the preceding walkthrough view generation method provided also includes calculating the depth differences between first intersection-points in the first intersection-point set and corresponding second intersection-points in the second intersection-point set one by one and using all first intersection-points whose depth differences are less than or equal to zero and all second intersection-points whose depth differences are greater than zero as the fused result of the initial three-dimensional model and the repaired three-dimensional model.

The preceding description is merely illustrative of preferred embodiments of the present disclosure and the technical principles used therein. Those of ordinary skill in the art should understand that the scope referred to in the disclosure is not limited to the technical solutions formed by the particular combination of the preceding technical features, but intended to cover other technical solutions which may be formed by any combination of the preceding technical features or their equivalents without departing from the concept of the disclosure. For example, technical solutions formed by mutual substitutions of the preceding feature and the technical features disclosed in the present disclosure (but not limited to) that have similar functions.

In addition, although the operations are depicted in a particular order, this should not be construed as requiring that such operations should be performed in the particular order shown or in a sequential order. In certain circumstances, multitasking and parallel processing may be advantageous. Similarly, although specific implementation details are included in the above discussion, these should not be construed as limiting the scope of the present disclosure. Some features described in the context of separate embodiments may also be implemented in combination in a single embodiment. Conversely, various features described in the context of a single embodiment may also be implemented in multiple embodiments, individually or in any suitable sub-combination.

1. A walkthrough view generation method, comprising:
acquiring an initial three-dimensional model and a repaired three-dimensional model corresponding to the initial three-dimensional model in a same spatial region, wherein the repaired three-dimensional model is obtained by repairing spatial information in the initial three-dimensional model;
determining a first intersection-point set between walkthrough light rays corresponding to current walkthrough parameters and the initial three-dimensional model and a second intersection-point set between the walkthrough light rays and the repaired three-dimensional model respectively, wherein the current walkthrough parameters comprise a walkthrough viewing position after moving and a walkthrough viewing angle after moving; and
fusing the initial three-dimensional model and the repaired three-dimensional model according to depth differences between intersection-points of the first intersection-point set and corresponding intersection-points of the second intersection-point set and rendering a fused result to obtain a current walkthrough view.

2. The method according to claim 1, wherein acquiring the initial three-dimensional model and the repaired three-dimensional model corresponding to the initial three-dimensional model in the same spatial region comprises:
generating the initial three-dimensional model according to a panoramic color image and a panoramic depth image in the same spatial region; and
generating the repaired three-dimensional model corresponding to the initial three-dimensional model according to a repaired panoramic color image corresponding to the panoramic color image and a repaired panoramic depth image corresponding to the panoramic depth image.

3. The method according to claim 2, wherein before generating the initial three-dimensional model according to the panoramic color image and the panoramic depth image in the same spatial region, the method further comprises:
generating the panoramic color image, generating the panoramic depth image, generating the repaired panoramic color image, and generating the repaired panoramic depth image respectively.

4. The method according to claim 3, wherein generating the panoramic depth image comprises:
acquiring a plurality of depth images from different viewing angles of shooting in the same spatial region; and
splicing the plurality of depth images to obtain the panoramic depth image.

5. The method according to claim 4, wherein splicing the plurality of depth images to obtain the panoramic depth image comprises:
splicing the plurality of depth images to obtain the panoramic depth image by using a same splicing method for generating the panoramic color image.

6. The method according to claim 5, wherein before splicing the plurality of depth images to obtain the panoramic depth image, the method comprises:
performing depth filling and depth enhancement on the plurality of depth images.

7. The method according to claim 3, wherein generating the panoramic depth image comprises:
inputting the panoramic color image into a first pre-trained neural network to obtain the panoramic depth image corresponding to the panoramic color image, wherein the first pre-trained neural network is trained based on a sample panoramic color image and a sample panoramic depth image corresponding to the sample panoramic color image.

8. The method according to claim 3, wherein generating the repaired panoramic depth image comprises:
determining a depth discontinuous edge in the panoramic depth image, wherein a first side of the depth discontinuous edge is depth foreground, and a second side of the depth discontinuous edge is depth background; and
performing depth expansion on the depth foreground and the depth background respectively to obtain the repaired panoramic depth image corresponding to the panoramic depth image.

9. The method according to claim 8, wherein generating the repaired panoramic color image comprises:
performing binarization processing on the repaired panoramic depth image to obtain a binarization mask map; and
determining the repaired panoramic color image corresponding to the panoramic color image according to the binarization mask map and the panoramic color image.

10. The method according to claim 9, wherein determining the repaired panoramic color image corresponding to the panoramic color image according to the binarization mask map and the panoramic color image comprises:
inputting the binarization mask map and the panoramic color image into a second pre-trained neural network and performing color repair on the panoramic color image through the second pre-trained neural network to obtain the repaired panoramic color image corresponding to the panoramic color image, wherein the second pre-trained neural network is trained based on a sample binarization mask map, a sample panoramic color image, and a sample repaired panoramic color image corresponding to the sample panoramic color image.

11. The method according to claim 1, wherein fusing the initial three-dimensional model and the repaired three-dimensional model according to the depth differences between the intersection-points of the first intersection-point set and the corresponding intersection-points of the second intersection-point set comprises:
calculating depth differences between first intersection-points in the first intersection-point set and corresponding second intersection-points in the second intersection-point set one by one; and
using all first intersection-points whose depth differences are less than or equal to zero and all second intersection-points whose depth differences are greater than zero as the fused result of the initial three-dimensional model and the repaired three-dimensional model.

12. (canceled)

13. A walkthrough view generation device, comprising a memory and a processor, wherein the memory stores a computer program, and the processor, when executing the computer program, performs:
acquiring an initial three-dimensional model and a repaired three-dimensional model corresponding to the initial three-dimensional model in a same spatial region, wherein the repaired three-dimensional model is obtained by repairing spatial information in the initial three-dimensional model;
determining a first intersection-point set between walkthrough light rays corresponding to current walkthrough parameters and the initial three-dimensional model and a second intersection-point set between the walkthrough light rays and the repaired three-dimensional model respectively, wherein the current walkthrough parameters comprise a walkthrough viewing position after moving and a walkthrough viewing angle after moving; and
fusing the initial three-dimensional model and the repaired three-dimensional model according to depth differences between intersection-points of the first intersection-point set and corresponding intersection-points of the second intersection-point set and rendering a fused result to obtain a current walkthrough view.

14. A non-transitory computer-readable storage medium storing a computer program, wherein the computer program, when executed by a processor, performs: acquiring an initial three-dimensional model and a repaired three-dimensional model corresponding to the initial three-dimensional model in a same spatial region, wherein the repaired three-dimensional model is obtained by repairing spatial information in the initial three-dimensional model;
determining a first intersection-point set between walkthrough light rays corresponding to current walkthrough parameters and the initial three-dimensional model and a second intersection-point set between the walkthrough light rays and the repaired three-dimensional model respectively, wherein the current walkthrough parameters comprise a walkthrough viewing position after moving and a walkthrough viewing angle after moving; and
fusing the initial three-dimensional model and the repaired three-dimensional model according to depth differences between intersection-points of the first intersection-point set and corresponding intersection-points of the second intersection-point set and rendering a fused result to obtain a current walkthrough view.

15. The device according to claim 13, wherein acquiring the initial three-dimensional model and the repaired three-dimensional model corresponding to the initial three-dimensional model in the same spatial region comprises:
generating the initial three-dimensional model according to a panoramic color image and a panoramic depth image in the same spatial region; and
generating the repaired three-dimensional model corresponding to the initial three-dimensional model according to a repaired panoramic color image corresponding to the panoramic color image and a repaired panoramic depth image corresponding to the panoramic depth image.

16. The device according to claim 15, wherein before generating the initial three-dimensional model according to the panoramic color image and the panoramic depth image in the same spatial region, the processor, when executing the computer program, performs:
generating the panoramic color image, generating the panoramic depth image, generating the repaired panoramic color image, and generating the repaired panoramic depth image respectively.

17. The device according to claim 16, wherein generating the panoramic depth image comprises:
acquiring a plurality of depth images from different viewing angles of shooting in the same spatial region; and
splicing the plurality of depth images to obtain the panoramic depth image.

18. The device according to claim 17, wherein splicing the plurality of depth images to obtain the panoramic depth image comprises:
splicing the plurality of depth images to obtain the panoramic depth image by using a same splicing method for generating the panoramic color image.

19. The device according to claim 18, wherein before splicing the plurality of depth images to obtain the panoramic depth image, the method comprises:
performing depth filling and depth enhancement on the plurality of depth images.

20. The device according to claim 16, wherein generating the panoramic depth image comprises:
inputting the panoramic color image into a first pre-trained neural network to obtain the panoramic depth image corresponding to the panoramic color image, wherein the first pre-trained neural network is trained based on a sample panoramic color image and a sample panoramic depth image corresponding to the sample panoramic color image.

21. The device according to claim 16, wherein generating the repaired panoramic depth image comprises:
determining a depth discontinuous edge in the panoramic depth image, wherein a first side of the depth discontinuous edge is depth foreground, and a second side of the depth discontinuous edge is depth background; and
performing depth expansion on the depth foreground and the depth background respectively to obtain the repaired panoramic depth image corresponding to the panoramic depth image.
